(19) United States
(12) Patent Application Publication
(10) Pub. No.: US 2019/0306959 A1
(43) Pub. Date: Oct. 3, 2019

(54) DEVICE CONTROL SYSTEM AND DETERMINATION METHOD

(71) Applicant: PANASONIC INTELLECTUAL PROPERTY MANAGEMENT CO., LTD., Osaka (JP)

(72) Inventors: Tatsumi SETOMOTO, Osaka (JP); Kohji HIRAMATSU, Osaka (JP); Hajime OZAKI, Osaka (JP)

(21) Appl. No.: 16/358,417

(22) Filed: Mar. 19, 2019

(30) Foreign Application Priority Data
Mar. 27, 2018 (JP) 2018-060960

(51) Int. Cl. H05B 37/02

(52) U.S. Cl. CPC H05B 37/0272; H05B 37/0227

(57) ABSTRACT

A lighting system includes: a first wireless communication unit configured to wirelessly transmit, to a lighting device, a control signal for controlling the lighting device, and to obtain a reception state of a radio wave at one of the first wireless communication unit and the lighting device which is transmitted by the other of the first wireless communication unit and the lighting device; and a determination unit configured to determine whether a person is present in a space in which the lighting device is installed, based on the reception state obtained.

### CROSS REFERENCE TO RELATED APPLICATION

This application claims the benefit of priority of Japanese Patent Application Number 2018-060960 filed on Mar.27, 2018, the entire content of which is hereby incorporated by reference.

### BACKGROUND

### 1. Technical Field

The present disclosure relates to a device control system and a determination method.

### 2. Description of the Related Art

A lighting system that controls a lighting device using wireless communication is known. As an example of such a lighting system, Japanese Unexamined Patent Application Publication No. 2009-87834 discloses an illumination control system which can be readily installed and is capable of controlling illumination depending on the state of a person in a room.

### SUMMARY

Now, in order for a device control system that controls a target device to be controlled using wireless communication to detect a target, such as a person and the like, and to control the target device according to a result detected, a sensor and the like for detecting the target is required separately.

An aspect of the present disclosure provides a device control system and a determination method which can determine whether a target is present.

A device control system according to an aspect of the present disclosure includes: a wireless communication unit configured to wirelessly transmit, to a target device to be controlled, a control signal for controlling the target device; an obtaining unit configured to obtain a reception state of a radio wave at one of the wireless communication unit and the target device, the radio wave being emitted by the other of the wireless communication unit and the target device; and a determination unit configured to determine whether a target is present in a space in which the target device is installed, based on the reception state obtained.

A determination method according to an aspect of the present disclosure is the determination method for determining whether a target is present, the determination method being performed by a device control system that includes a wireless communication unit configured to wirelessly transmit, to a target device to be controlled, a control signal for controlling the target device, the determination method includes: obtaining a reception state of a radio wave at one of the wireless communication unit and the target device, the radio wave being emitted by the other of the wireless communication unit and the target device; and determining whether a target is present in a space in which the target device is installed, based on the reception state obtained.

According to an aspect of the present disclosure, a device control system and a determination method which can determine whether a target is present can be realized.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a block diagram illustrating a functional configuration of a lighting system according to an embodiment;

FIG. 2 is a diagram illustrating an example of an arrangement of a plurality of lighting devices included in the lighting system according to the embodiment;

FIG. 3 is a diagram illustrating the temporal variation of reception strength in a time during which a person is not present and in a time during which a person is present;

FIG. 4 is a diagram schematically illustrating the strength of fading;

FIG. 5 is a sequence diagram of Operation Example 1 of the lighting system according to the embodiment;

FIG. 6 is a sequence diagram of Operation Example 2 of the lighting system according to the embodiment; and

FIG. 7 is a sequence diagram of Operation Example 3 of the lighting system according to the embodiment.

### DETAILED DESCRIPTION OF THE EMBODIMENTS

The following specifically describes embodiments, with reference to the drawings. Note that the embodiments described below each show a general or specific example. The numerical values, shapes, materials, elements, the arrangement and connection of the elements, steps, and the order of the steps, for instance, described in the following embodiments are mere examples, and thus are not intended to limit the present disclosure. Therefore, among the elements in the following embodiments, elements not recited in any of the independent claims defining the most generic part of the present disclosure are described as optional elements.

Note that the drawings are schematic diagrams, and do not necessarily provide strictly accurate illustration. Throughout the drawings, the same numeral is given to substantially the same element, and redundant description is omitted or simplified.

### Embodiment

### [Configuration]

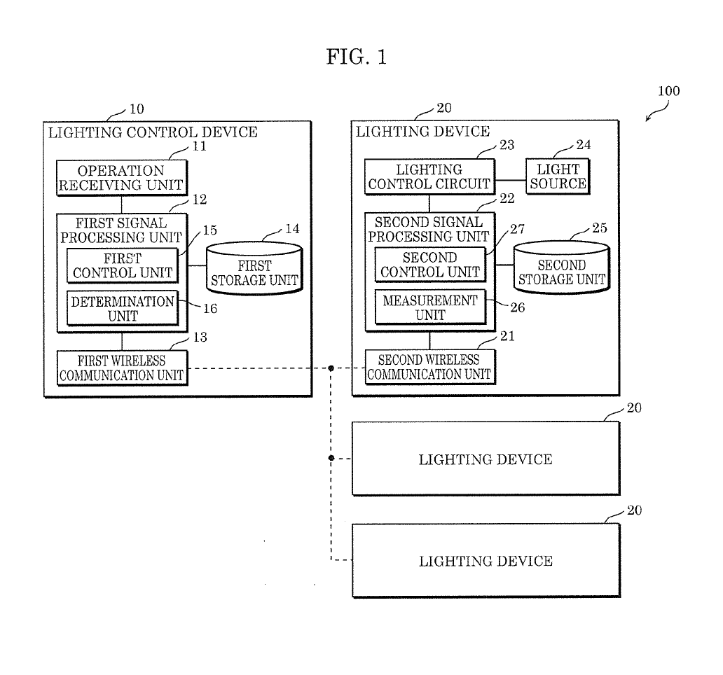

Firstly, the configuration of a lighting system according to an embodiment will be described. FIG. 1 is a block diagram illustrating the functional configuration of the lighting system according to the embodiment.

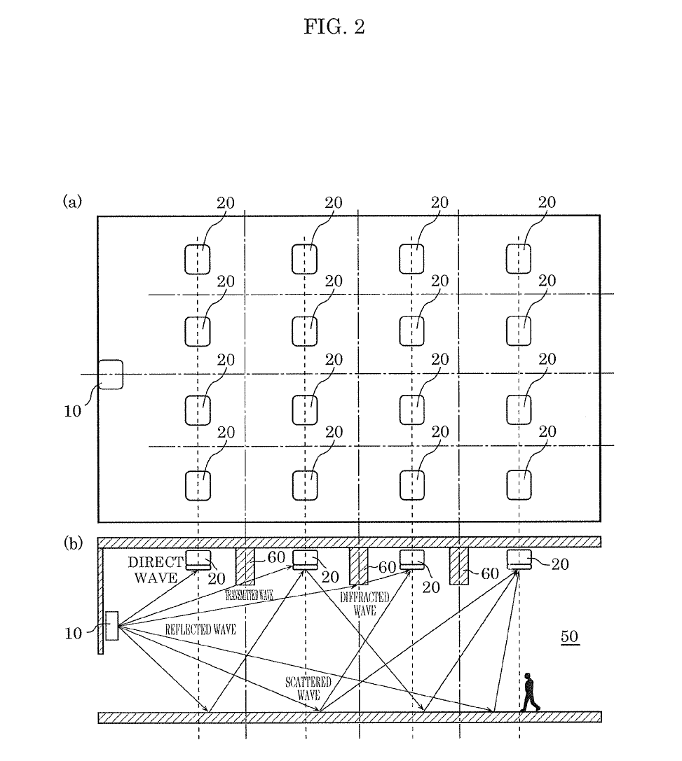

As illustrated in FIG. 1, lighting system 100 according to the embodiment includes lighting control device 10 and a plurality of lighting devices 20. Lighting control device 10 controls the lighting state of the plurality of lighting devices 20 by transmitting a control signal to each of the plurality of lighting devices 20. The plurality of lighting devices 20 are arranged on a ceiling of a facility, such as a gymnasium. FIG. 2 is a diagram illustrating an example of the arrangement of the plurality of lighting devices 20. Part (a) of FIG. 2 is illustrated in a plan view, and part (b) of FIG. 2 is illustrated in a side view.

A user can manually operate lighting system 100 to change the lighting state of the plurality of lighting devices 20. In addition, lighting system 100 can perform automatic lighting operation which determines whether a person is present and automatically start the emission of light by lighting device 20 in an area in which the person is determined to be present.

In the automatic lighting operation, lighting control device 10 determines whether a person is present based on the reception state of a radio wave at each of the plurality of lighting devices 20 which is transmitted by lighting control device 10. As illustrated in part (b) of FIG. 2, radio waves emitted by lighting control device 10 which reach the plurality of lighting devices 20 include, for instance, a direct wave, a transmitted wave, a diffracted wave, and a scattered wave.

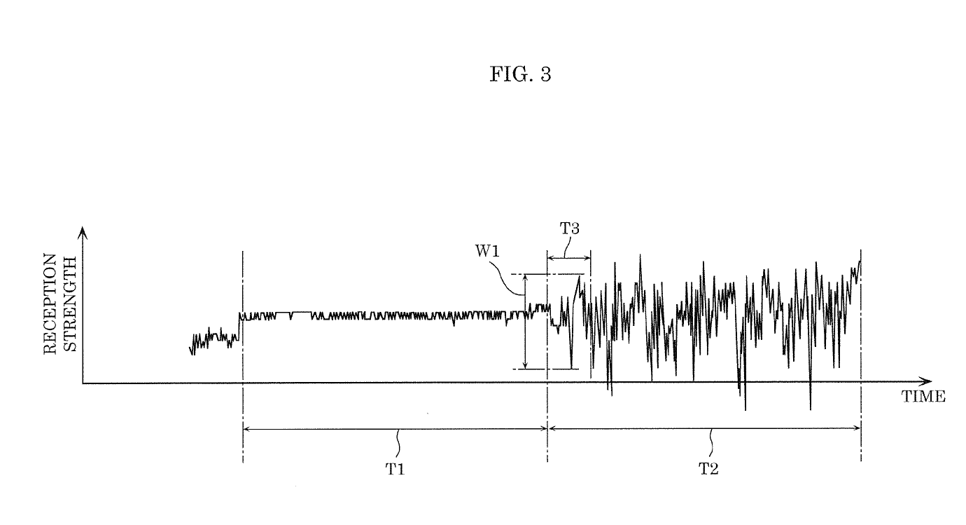

Here, in time T2 during which a person is present in space 50, a phenomenon called fading in which a radio wave in space 50 is disrupted more than a radio wave in time T1 during which a person is not present in space 50 occurs. When a person is present in space 50, the reception strength of a radio wave at lighting device 20, which is transmitted by lighting control device 10, varies considerably. FIG. 3 is a diagram illustrating the temporal variation of reception strength in time T1 during which a person is not present and in time T2 during which a person is present.

As illustrated in FIG. 3, the amplitude of reception strength increases when a person is present in space 50. Accordingly, the automatic lighting operation performed by lighting system 100 determines whether a person is present based on such amplitude of reception strength.

In this way, lighting system 100 can determine whether a person is present using wireless communication which is used for transmitting a control signal. In other words, lighting system 100 can determine whether a person is present without using a dedicated human sensor, for instance.

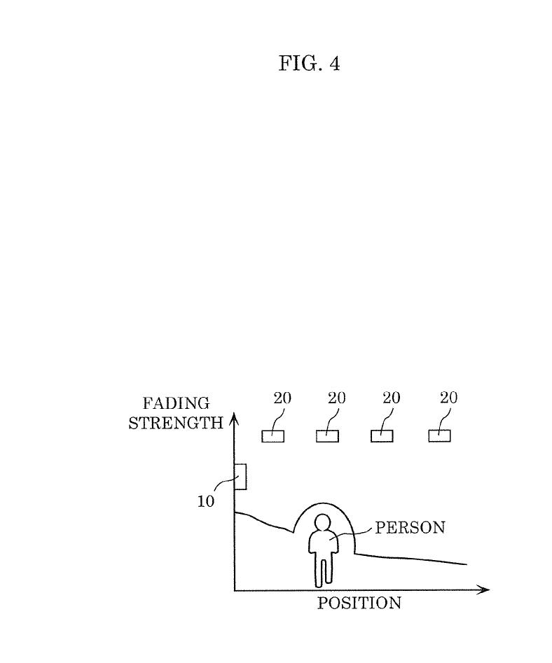

Note that, as illustrated in FIG. 4, when fading occurs due to the presence of a person, it is considered that the reception strength of a radio wave at lighting device 20 located directly above the person is affected most. FIG. 4 is a diagram schematically illustrating the strength of fading. This tendency becomes apparent when a radio wave from lighting control device 10 does not directly reach lighting device 20 due to an obstruction between lighting control device 10 and lighting device 20 (called over-the-horizon communication, for instance).

Hereinafter, each of the structural elements included in lighting system 100 will be described in detail with continuous reference to FIG. 1 and FIG. 2.

### [Lighting Control Device]

Firstly, the configuration of lighting control device 10 will be described. Lighting control device 10 controls the lighting state of the plurality of lighting devices 20 by transmitting a control signal to each of the plurality of lighting devices 20. Lighting control device 10 includes operation receiving unit 11, first signal processing unit 12, first wireless communication unit 13, and first storage unit 14.

Operation receiving unit 11 receives a user operation. Specifically, operation receiving unit 11 is realized by, for instance, a hardware key, or a touch panel. Note that operation receiving unit 11 may be a user interface device different from lighting control device 10.

First signal processing unit 12 includes determination unit 16 that processes a signal for determining whether a person is present and first control unit 15 that processes a signal for controlling the lighting state of lighting device 20. First signal processing unit 12 is realized by, for instance, a microcomputer, but may be realized by a processor or a dedicated circuit.

First wireless communication unit 13 is a wireless communication circuit for lighting control device 10 to wirelessly communicate with lighting device 20. More specifically, wireless communication is radio wave communication. For example, first wireless communication unit 13 emits a radio wave for reception strength measurement based on the control of determination unit 16. The radio wave has a frequency of at least 700 MHz and at most 2.4 GHz, for instance. Note that a visible light and an infrared light are not included in the radio wave. In addition, first wireless communication unit 13 is an example of an obtaining unit, and obtains reception strength information indicating the reception strength of a radio wave at lighting device 20. First wireless communication unit 13 wirelessly transmit, to lighting device 20, a control signal for controlling lighting device 20, based on the control of first control unit 15.

First storage unit 14 is a storage device that stores, for instance, a control program executed by first signal processing unit 12. First storage unit 14 is realized by a semiconductor memory, for instance.

### [Lighting Device]

Next, lighting device 20 will be described. Lighting device 20 is an example of a target device to be controlled by lighting control device 10. Specifically, lighting device 20 is a lighting device for high ceilings. Note that a specific mode of lighting device 20 is not limited.

Lighting device 20 includes second wireless communication unit 21, second signal processing unit 22, lighting control circuit 23, light source 24, and second storage unit 25.

Second wireless communication unit 21 is a wireless communication circuit for lighting device 20 to wirelessly communicate with lighting control device 10. More specifically, wireless communication is radio wave communication. For example, second wireless communication unit 21 receives, from lighting control device 10, a radio wave for reception strength measurement and a control signal. In addition, second wireless communication unit 21 transmits reception strength information to lighting control device 10.

Second signal processing unit 22 includes measurement unit 26 and second control unit 27. Second signal processing unit 22 is realized by, for instance, a microcomputer, but may be realized by a processor or a dedicated circuit.

Measurement unit 26 measures the reception strength of a radio wave (received signal strength indication (RSSI)) which second wireless communication unit 21 receives from lighting control device 10. Note that measurement unit 26 may be realized as a device integrated with second wireless communication unit 21.

Second control unit 27 performs lighting control on light source 24 via lighting control circuit 23 based on a control signal received by second wireless communication unit 21. The lighting control is dimming control that includes, for instance, starting and ceasing the emission of light, but may be toning control if light source 24 is capable of toning. In addition, the lighting control may be scheduled control that controls light source 24 based on a schedule.

Lighting control circuit 23 supplies voltage and current to light source 24 based on the control of second control unit 27. Specifically, lighting control circuit 23 is a dimming control circuit, such as a pulse width modulation (PWM) control circuit.

Light source 24 is a white light source for lighting that emits light using voltage and current supplied from lighting control circuit 23. Specifically, light source 24 is realized by, for instance, a fluorescence tube or a light emitting diode (LED). Light source 24 may be a semiconductor light-emitting element, such as a semiconductor laser, or a solid-state light-emitting element, such as an organic or inorganic electroluminescent (EL) element.

Second storage unit 25 is a storage device that stores, for instance, a control program executed by second control unit 27. Second storage unit 25 is realized by a semiconductor memory, for instance.

### OPERATION EXAMPLE 1

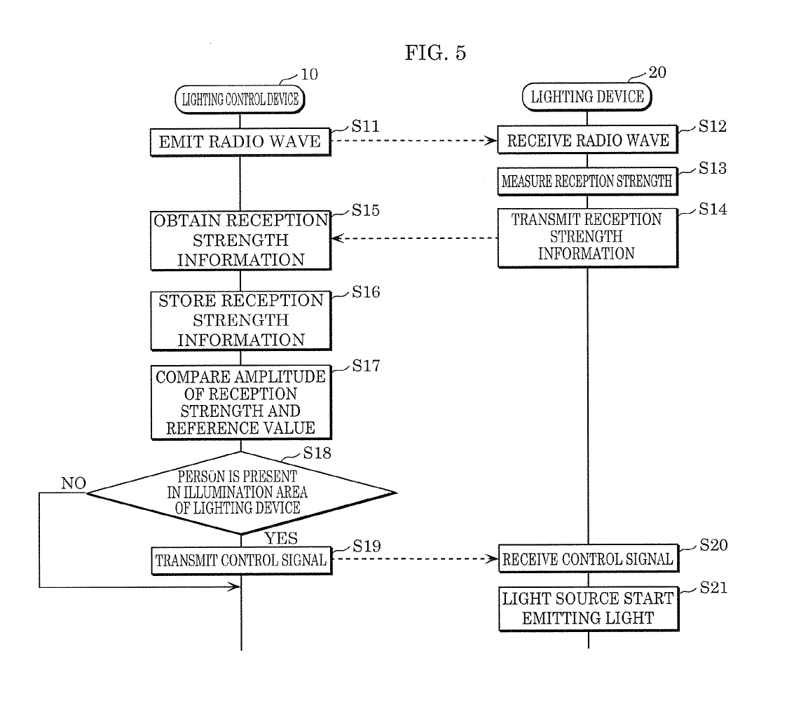

Next, Operation Example 1 of lighting system 100 will be described. FIG. 5 is a sequence diagram of Operation Example 1 of lighting system 100. Note that the sequence diagram of FIG. 5 illustrates processing performed between one lighting control device 10 and one lighting device 20, but the processing illustrated in FIG. 5 is actually performed on each of the plurality of lighting devices 20.

Firstly, first wireless communication unit 13 of lighting control device 10 emits a radio wave for reception strength measurement based on the control of determination unit 16 (S11). Second wireless communication unit 21 of lighting device 20 receives the radio wave (S12), and measurement unit 26 measures the reception strength of the radio wave received (S13). More specifically, measurement unit 26 measures the difference between the minimum value and the maximum value of reception strength in a predetermined period. That is to say, measurement unit 26 measures the amplitude of reception strength. For example, the amplitude of reception strength in predetermined time T3 in FIG. 3 is amplitude W1. Next, second signal processing unit 22 causes second wireless communication unit 21 to transmit reception strength information indicating the amplitude of the reception strength measured (S14).

First wireless communication unit 13 of lighting control device 10 obtains the reception strength information transmitted by second wireless communication unit 21 (S15), and determination unit 16 stores, into first storage unit 14, the reception strength information received (S16).

Next, determination unit 16 compares the amplitude of the reception strength indicated in the reception strength information obtained in step S15 (hereinafter, also indicated as the amplitude of the present reception strength) and the reference amplitude stored in advance in first storage unit 14 (S17) to determine whether a person is present in the illumination area of lighting device 20 (S18). The amplitude of the reception strength is, in other words, the amplitude of a radio wave received.

Specifically, determination unit 16 determines whether the amplitude of the present reception strength is greater than the amplitude of the reference amplitude by a predetermined value. The reference amplitude indicates the amplitude of reception strength in the state in which a person is not present in space 50. The reference amplitude is stored in first storage unit 14 in advance by performing the same processing as indicated in steps S11 through S16 in the state in which a person is not present in space 50. In other words, the reference amplitude is the default amplitude of reception strength. In addition, the predetermined value is a value greater than or equal to zero, for instance.

The fact that the amplitude of the present reception strength is greater than the reference amplitude by at least a predetermined value indicates that the amplitude of the present reception strength has greatly changed from the amplitude of reception strength in a state in which a person is not present. That is to say, it is estimated that a person is present in the illumination area directly under lighting device 20 in space 50. Accordingly, determination unit 16 determines that a person is present when the amplitude of the present reception strength is greater than the reference amplitude by at least the predetermined value (YES in S18). When determination unit 16 determines that a person is present in the illumination area of lighting device 20 among space 50, first control unit 15 causes first wireless communication unit 13 to transmit a control signal for lighting device 20 to start emitting light (S19).

When the control signal transmitted in step S19 is received by second wireless communication unit 21 of lighting device 20 (S20), second control unit 27 causes light source 24 to start emitting light via lighting control circuit 23 (S21). Note that when it is determined that a person is not present in step S18 (NO in S18), the control signal will not be transmitted, and thus lighting device 20 will not start emitting light.

In lighting system 100, the operation illustrated in the sequence diagram of FIG. 5 is regularly repeated. That is to say, fading in space 50 is steadily observed.

As described above, lighting system 100 in Operation Example 1 can determine, by comparing the amplitude of the present reception strength and the reference amplitude, whether a person is present in space 50.

Note that in step S18, whether a person is present in space 50 may be determined based on the amplitude of reception strength measured multiple times. Specifically, the mean value, the minimum value, the median value, or the mode value of the amplitude of reception strength measured multiple times may be used for the determination. The same applies to the reference amplitude. This improves the accuracy of determining whether a person is present in space 50.

In addition, in step S21, the emission of light by light source 24 may be ceased, and the light emitted by light source 24 may be dimmed or toned. That is to say, the control signal received in step S20 may be the control signal for at least one of: (i) starting the emission of light by lighting device 20; (ii) ceasing the emission of light by lighting device 20; (iii) dimming light emitted by lighting device 20; and (iv) toning light emitted by lighting device 20.

### OPERATION EXAMPLE 2

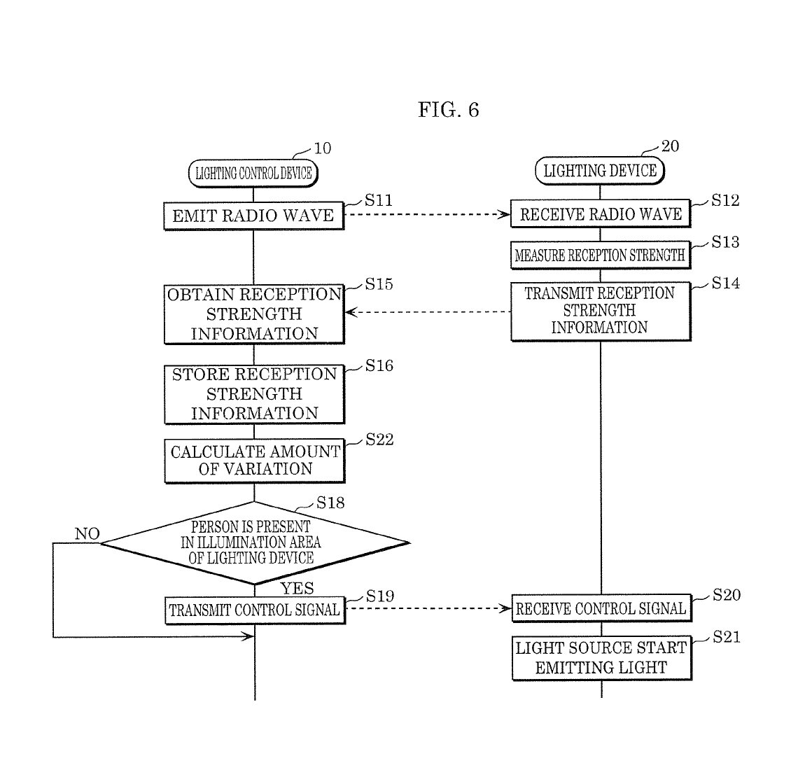

Next, Operation Example 2 of lighting system 100 will be described. FIG. 6 is a sequence diagram of Operation Example 2 of lighting system 100. Note that the sequence diagram of FIG. 6 illustrates processing performed between one lighting control device 10 and one lighting device 20, but the processing illustrated in FIG. 6 is actually performed on each of the plurality of lighting devices 20.

Steps S11 through S16 are the same as steps S11 through S16 described in Operation Example 1. After step S16, determination unit 16 calculates the difference in the amount of variation between the amplitude of the present reception strength obtained in step S15 and the amplitude of the reception strength obtained at timing immediately before the amplitude of the present reception strength is obtained in S15 (that is, the amount of variation over time) (S22). Determination unit 16 determines whether a person is present in the illumination area of lighting device 20 based on the amount of variation calculated (S18).

Specifically, determination unit 16 determines whether the absolute value of the amount of variation calculated is greater than a threshold. The threshold is a value greater than or equal to zero, for instance. The fact that the absolute value of the amount of variation calculated is greater than the threshold indicates that the amplitude of reception strength has greatly changed. That is to say, it is estimated that a person is present in the illumination area directly under lighting device 20 in space 50. Accordingly, determination unit 16 determines that a person is present when the absolute value of the amount of variation calculated is greater than the threshold (YES in S18). The processing from step S19 onward is the same as the processing described in Operation Example 1.

As described above, lighting system 100 in Operation Example 2 can determine whether a person is present based on the amount of variation in the amplitude of reception strength.

### OPERATION EXAMPLE 3

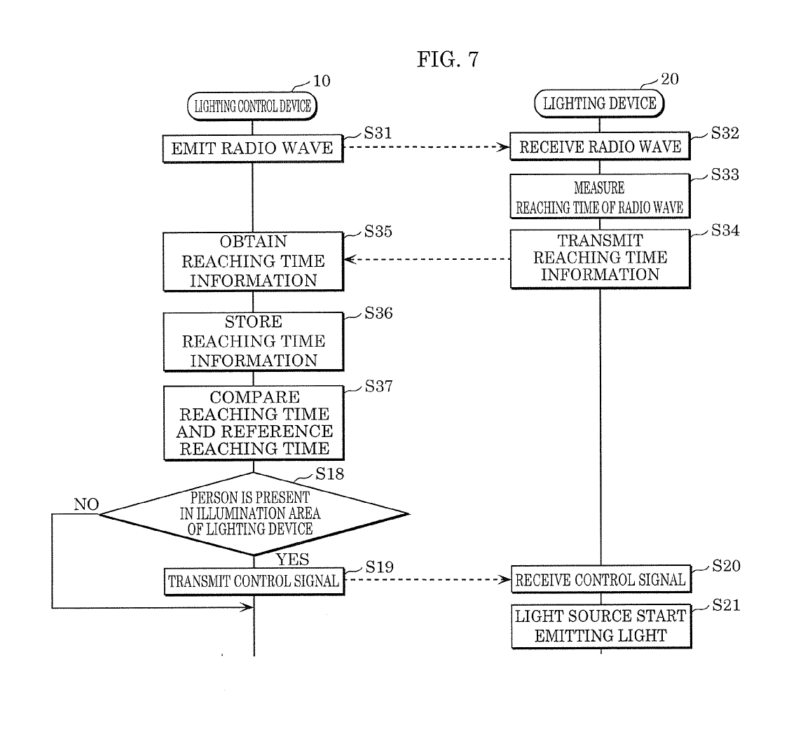

Next, Operation Example 3 of lighting system 100 will be described. In Operation Examples 1 and 2, the reception state of a radio wave at second wireless communication unit 21 of lighting device 20, which is transmitted by first wireless communication unit 13 of lighting control device 10, is represented by the amplitude of reception strength. Operation Example 3 describes the case where the above-mentioned reception state is represented by the reaching time of a radio wave. FIG. 7 is a sequence diagram of Operation Example 3 of lighting system 100. Note that the sequence diagram of FIG. 7 illustrates processing performed between one lighting control device 10 and one lighting device 20, but the processing illustrated in FIG. 7 is actually performed on each of the plurality of lighting devices 20.

Firstly, first wireless communication unit 13 of lighting control device 10 emits a radio wave for measurement based on the control of determination unit 16 (S31). Second wireless communication unit 21 of lighting device 20 receives the radio wave (S32). Here, the radio wave for measurement includes the information indicating the transmission timing of the radio wave.

Next, second signal processing unit 22 measures the reaching time of the radio wave for measurement (S33). Specifically, second signal processing unit 22 measures, as the reaching time, the difference between the transmission timing indicated in the information included in the above-mentioned radio wave for measurement and the reception timing of the radio wave for measurement. Next, second signal processing unit 22 causes second wireless communication unit 21 to transmit reaching time information indicating the reaching time measured (S34).

First wireless communication unit 13 of lighting control device 10 obtains the reaching time information transmitted by second wireless communication unit 21 (S35), and determination unit 16 stores the reaching time information received into first storage unit 14 (S36).

Next, determination unit 16 compares the reaching time indicated in the reaching time information obtained in step S35 (hereinafter, also indicated as the present reaching time) with the reference reaching time stored in advance in first storage unit 14 (S37) to determine whether a person is present in the illumination area of lighting device 20 (S18).

Specifically, determination unit 16 determines whether the difference in time between the present reaching time and the reference reaching time is greater than a predetermined time. The reference reaching time is the reaching time of a radio wave for measurement in the state in which a person is not present in space 50. The reference reaching time is stored into first storage unit 14 in advance by performing the same processing as indicated in steps S31 through S36 in the state in which a person is not present in space 50. In other words, the reference reaching time is the default reaching time. In addition, the predetermined time is the time length greater than or equal to zero, for instance.

The fact that the difference in time between the present reaching time and the reference reaching time is greater than or equal to the predetermined time indicates that the state of radio wave propagation directly under lighting device 20 has changed. That is to say, it is estimated that a person is present in the illumination area directly under lighting device 20 in space 50. Accordingly, determination unit 16 determines that a person is present when the difference in time between the present reaching time and the reference reaching time is greater than or equal to the predetermined time (YES in S18). The processing from step S19 onward is the same as the processing described in Operation Example 1. Note that, like Operation Example 2, the amount of variation in reaching time may be calculated in step S37.

As described above, lighting system 100 in Operation Example 3 can determine whether a person is present in space 50 based on the reaching time which is the time taken for lighting device 20 to receive a radio wave emitted by first wireless communication unit 13.

Note that if the reaching time is stored in first storage unit 14, first control unit 15 can control the transmission timing of a control signal to each of the plurality of lighting devices 20 while taking the reaching time stored in first storage unit 14 into consideration. In this manner, it is possible to reduce the timing difference when the plurality of lighting devices 20 are caused to start emitting light simultaneously.

### [Variation]

In Operation Examples 1 to 3, the reception state of a radio wave at lighting device 20, which is transmitted by first wireless communication unit 13 of lighting control device 10, is used for determining whether a person is present. However, the reception state of a radio wave at first wireless communication unit 13, which is transmitted by lighting device 20, may be used for determining whether a person is present. That is to say, lighting system 100 may use the reception state of a radio wave at one of first wireless communication unit 13 and lighting device 20, which is transmitted by the other of first wireless communication unit 13 and lighting device 20, for determining whether a person is present.

In addition, it is not essential for lighting system 100 to determine whether a person is present. Lighting system 100 may determine whether a target other than a person is present. The target may be, or may not be a living being, such as a person or an animal.

In addition, lighting system 100 is an example of a device control system. A target device to be controlled in the device control system is not limited to lighting device 20. For example, the target device may be an air conditioner. In this case, first control unit 15 causes first wireless communication unit 13 to transmit a control signal to start the operation of the air conditioner when determination unit 16 determines that a person is present, for instance.

In addition, the state of radio wave propagation in space 50 is actually very complicated. For example, when a person is present directly under a second lighting device among the plurality of lighting devices 20, there may be a case where the reception state of a radio wave at a first lighting device that is different from the second lighting device changes more than the reception state of a radio wave at the second lighting device. In such a case, first control unit 15 may cause, based on a user setting, the second lighting device to start emitting light. That is to say, first control unit 15 may cause the second lighting device to start emitting light when determination unit 16 determines that a person is present in the illumination area of the first lighting device in space 50. In this case, operation receiving unit 11 receives a user operation in advance in order for the second lighting device to start emitting light instead of the first lighting device. The identification information of a target lighting device identified based on the user operation received is stored into first storage unit 14 as user setting information to be referred by first control unit 15.

### [Effects, etc.]

As described above, lighting system 100 includes first wireless communication unit 13 which wirelessly transmits, to lighting device 20, a control signal for controlling lighting device 20 and obtains a reception state of a radio wave at one of first wireless communication unit 13 and lighting device 20, which is emitted by the other of first wireless communication unit 13 and lighting device 20. Lighting system 100 also includes determination unit 16 which determines whether a target is present in space 50 in which lighting device 20 is installed, based on the reception state obtained. Lighting system 100 is an example of a device control system, and lighting device 20 is an example of a target device. A person is an example of a target.

Such lighting system 100 can determine whether a person is present, based on the reception state. It is an advantage that lighting system 100 is not required to add, for instance, a sensor for detecting a target, such as a person.

In addition, for example, the above reception state is represented by the amplitude of the radio wave received.

Lighting system 100 having such a feature as above can determine whether a person is present based on the amplitude of a radio wave received.

In addition, for example, determination unit 16 determines whether a person is present in space 50 in which lighting device 20 is installed, based on the amount of variation in the amplitude of the radio wave received.

Lighting system 100 having such a feature as above can determine whether a person is present based on the amount of variation in the amplitude of a radio wave received.

In addition, for example, lighting system 100 further includes first storage unit 14 which stores reference amplitude that indicates the amplitude of the radio wave received in a state in which no person is present in space 50. Determination unit 16 determines whether the person is present in space 50 by comparing the amplitude of the radio wave received and the reference amplitude.

Lighting system 100 having such a configuration as above can determine whether a person is present by comparing the amplitude of a radio wave received and the reference amplitude.

In addition, for example, determination unit 16 determines whether the person is present in space 50 based on the amplitude of the radio wave received which has been measured multiple times.

Lighting system 100 having such a feature as above can improve the accuracy of determining whether a person is present.

In addition, for example, the reception state is represented by reaching time which is a time taken for one of first wireless communication unit 13 and lighting device 20 to receive the radio wave emitted by the other of first wireless communication unit 13 and lighting device 20.

Lighting system 100 having such a feature as above can determine whether a person is present based on the reaching time.

In addition, for example, lighting system 100 further includes first control unit 15 to cause, based on the result of determination as to whether the person is present, first wireless communication unit 13 to transmit a control signal.

Lighting system 100 having such a configuration as above can control lighting device 20, based on the result of determination as to whether a person is present.

In addition, for example, when determination unit 16 determines that the person is present in space 50, first control unit 15 causes first wireless communication unit 13 to transmit the control signal for lighting device 20 to start operation.

Lighting system 100 having such a feature as above can cause lighting device 20 to start operation based on the result of determination as to whether a person is present.

In addition, for example, determination unit 16 determines, based on the reception state obtained, whether the person is present in the illumination area of lighting device 20 in space 50 in which lighting device 20 is installed.

Lighting system 100 having such a feature as above can determine whether a person is present in the illumination area of lighting device 20, based on the reception state.

In addition, for example, first control unit 15 causes first wireless communication unit 13 to transmit a control signal for lighting device 20 to start emitting light when determination unit 16 determines that the person is present in the illumination area of lighting device 20 in space 50.

Lighting system 100 having such a feature as above can determine whether a person is present in the illumination area of lighting device 20, based on the reception state.

In addition, for example, lighting system 100 includes a first lighting device and a second lighting device each of which is lighting device 20, and first wireless communication unit 13 transmits the control signal to each of the first lighting device and the second lighting device. Lighting system 100 further includes operation receiving unit 11 which receives a user operation for the second lighting device to start the emission of light when determination unit 16 determines that the person is present in the illumination area of the first lighting device in space 50.

Lighting system 100 having such features and configurations as above is suitable for the case where the reception state of a radio wave at the first lighting device, which is different from the second lighting device, changes more than the reception state of a radio wave at the second lighting device when a person is present directly under the second lighting device.

In addition, for example, the control signal is a signal for at least one of: (i) starting the emission of light by lighting device 20; (ii) ceasing the emission of light by lighting device 20; (iii) dimming light emitted by lighting device 20; and (iv) toning light emitted by lighting device 20.

Lighting system 100 having such a feature as above can perform at least one of: (i) starting the emission of light by lighting device 20; (ii) ceasing the emission of light by lighting device 20; (iii) dimming light emitted by lighting device 20; and (iv) toning light emitted by lighting device 20.

In addition, for example, the radio wave has a frequency of at least 700 MHz and at most 2.4 GHz.

Lighting system 100 having such a feature as above can emit a radio wave having a frequency of at least 700 MHz and at most 2.4 GHz.

In addition, for example, in space 50, obstruction 60 is disposed between first wireless communication unit 13 and lighting device 20.

Lighting system 100 having such a configuration can determine whether a person is present using the state of radio wave propagation in space 50 in which a radio wave does not directly reach lighting device 20 from lighting control device 10.

### Other Embodiments

The above has described the embodiments, yet the present disclosure is not limited to the above embodiments.

For example, the application of the device control system is not particularly limited. The device control system can also be used as, for instance, a security system which determines whether an intruder to a facility is present.

In addition, the methods for communication between devices described in the above embodiments are mere examples. The methods for communication between devices are not particularly limited. For example, the wireless communication performed between the devices uses a communication standard, such as specified low power radio, ZigBee (registered trademark), Bluetooth (registered trademark), or Wi-Fi (registered trademark).

In addition, in the above embodiments, processing performed by a particular processing unit may be performed by another processing unit. Furthermore, the order of processes may be changed, and the processes may be performed in parallel.

Moreover, in the above embodiments, the structural elements such as the control unit may be realized by executing a software program suitable for each structural element. Each structural element may be realized by means of a program executing unit, such as a CPU or a processor, reading and executing a software program recorded on a recording medium such as a hard disk or a semiconductor memory.

In addition, the structural elements such as the control unit may be realized by a hardware product. For example, the structural elements such as the control unit may be circuits or integrated circuits. These circuits may constitute a single circuit as a whole or may be individual circuits. Furthermore, each of these circuits may be a general-purpose circuit or may be a dedicated circuit.

Note that the general or specific aspects of the present disclosure may be realized by a system, a device, a method, an integrated circuit, a computer program, or a computer-readable recording medium such as a CD-ROM. The general or specific aspects of the present disclosure may also be realized by any combination of a system, a device, a method, an integrated circuit, a computer program, and a recording medium. For example, the present disclosure may be realized as a lighting control device and may also be realized as a determination method for determining whether a person is present. In addition, the present disclosure may be realized as a program for causing a computer to perform the determination method for determining whether a person is present, and may also be realized as a non-transitory computer-readable recording medium on which such a program is recorded.

The present disclosure also encompasses: embodiments achieved by applying various modifications conceivable to those skilled in the art to each embodiment; and embodiments achieved by arbitrarily combining the structural elements and the functions of each embodiment without departing from the essence of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A device control system, comprising:
a wireless communication unit configured to wirelessly transmit, to a target device to be controlled, a control signal for controlling the target device;
an obtaining unit configured to obtain a reception state of a radio wave at one of the wireless communication unit and the target device, the radio wave being emitted by the other of the wireless communication unit and the target device; and
a determination unit configured to determine whether a target is present in a space in which the target device is installed, based on the reception state obtained.

2. The device control system according to claim 1, wherein
the reception state is represented by amplitude of the radio wave received.

3. The device control system according to claim 1, wherein
the determination unit is configured to determine whether a target is present in a space in which the target device is installed, based on an amount of variation in amplitude of the radio wave received.

4. The device control system according to claim 2, further comprising:
a storage unit configured to store reference amplitude that indicates amplitude of the radio wave received in a state in which no target is present in the space, wherein
the determination unit is configured to determine whether the target is present in the space by comparing the amplitude of the radio wave received and the reference amplitude.

5. The device control system according to claim 2, wherein
the determination unit is configured to determine whether the target is present in the space, based on the amplitude of the radio wave received which has been measured multiple times.

6. The device control system according to claim 1, wherein
the reception state is represented by a time taken for the one of the wireless communication unit and the target device to receive the radio wave emitted by the other of the wireless communication unit and the target device.

7. The device control system according to claim 1, further comprising:
a control unit configured to cause, based on a result of determination by the determination unit as to whether the target is present, the wireless communication unit to transmit the control signal.

8. The device control system according to claim 7, wherein
when the determination unit determines that the target is present in the space, the control unit is configured to cause the wireless communication unit to transmit the control signal, the control signal being a signal for the target device to start operation.

9. The device control system according to claim 7, wherein:
the target device is a lighting device, and
the determination unit is configured to determine, based on the reception state obtained, whether the target is present in an illumination area of the lighting device in the space in which the lighting device is installed.

10. The device control system according to claim 9, wherein
the control unit is configured to cause the wireless communication unit to transmit the control signal when the determination unit determines that the target is present in the illumination area of the lighting device in the space, the control signal being a signal for the lighting device to start emitting light.

11. The device control system according to claim 10, wherein:
the device control system includes a first lighting device and a second lighting device each of which is the lighting device,
the wireless communication unit is configured to transmit the control signal to each of the first lighting device and the second lighting device, and
the device control system further comprises:
an operation receiving unit configured to receive a user operation for the second lighting device to start emission of light when the determination unit determines that the target is present in the illumination area of the first lighting device in the space.

12. The device control system according to claim 9, wherein
the control signal is a signal for at least one of: (i) starting the emission of light by the lighting device; (ii) ceasing the emission of light by the lighting device; (iii) dimming light emitted by the lighting device; and (iv) toning light emitted by the lighting device.

13. The device control system according to claim 1, wherein
the radio wave has a frequency of at least 700 MHz and at most 2.4 GHz.

14. The device control system according to claim 1, wherein
in the space, an obstruction is disposed between the wireless communication unit and the target device.

15. A determination method for determining whether a target is present, the determination method being performed by a device control system that includes a wireless communication unit configured to wirelessly transmit, to a target device to be controlled, a control signal for controlling the target device, the determination method comprising:
obtaining a reception state of a radio wave at one of the wireless communication unit and the target device, the radio wave being emitted by the other of the wireless communication unit and the target device; and
determining whether a target is present in a space in which the target device is installed, based on the reception state obtained.

16. The determination method according to claim 15, wherein
the reception state is represented by amplitude of the radio wave received.

17. The determination method according to claim 16, wherein
in determining whether a target is present, whether a target is present in a space in which the target device is installed is determined based on an amount of variation in amplitude of the radio wave received.

18. The determination method according to claim 16, wherein
in determining whether the target is present, whether the target is present in the space is determined by comparing the amplitude of the radio wave received and reference amplitude.

19. The determination method according to claim 16, wherein
in determining whether the target is present, whether the target is present in the space is determined based on the amplitude of the radio wave received which has been measured multiple times.

20. The determination method according to claim 15, wherein
the reception state is represented by a time taken for the one of the wireless communication unit and the target device to receive the radio wave being emitted by the other of the wireless communication unit and the target device.
